(19) United States
(12) Patent Application Publication
(10) Pub. No.: US 2004/0200248 A1
(43) Pub. Date: Oct. 14, 2004

(54) Fertilizer composition for 3-level plant nutrition and for insitu biosynthesis of slow-release nourishment

(76) Inventor: Leslie Kirkegaard, Ijamsville, MD (US)

Correspondence Address: BIOTECHPATENT.NET, LLC, No. 221, 5284 Randolph Road, Rockville, MD, 20852, US

(21) Appl. No.: 10/412,257

(22) Filed: Apr. 14, 2003

(51) Int. Cl. C05F 11/08

(52) U.S. Cl. 71/28

(57) ABSTRACT

This invention provides for fertilizer compositions of 3-Level Plant Nutrition and for Insitu Biosynthesis of Slow-Release Nourishment. Methods for feeding plants while simultaneously harnessing and sustaining microbes are disclosed. The invention's rejuvenating benefits of 3-Level nutrition puts an end to orchid media going bad.

### FIELD OF THE INVENTION

This present invention relates to a fertilizer composition for good nutrition of orchids and other plants comprising minerals, a variety of simple carbohydrates, aminoacids, vitamins, and a good diet of a complex source of nutrients for microbes.

### BACKGROUND OF THE INVENTION

Orchid, common name for all members of the family Orchidaceae, a group of attractively flowered plants that comprises the order Orchidales. There are from 400 to 800 genera of orchids, with at least 15,000 species, depending on the authorities replied upon. Orchids are found throughout most of the world and are especially abundant in tropical regions. These woody perennial plants grow in soil or on other plants. Most species manufacture their own food, but some live on dead organic material or have microbes living in or around their roots to help obtain nourishment.

All orchids have the same bilaterally symmetrical flower structure, with three sepals, but the flowers vary greatly in color and shape. One of the petals, called the lip, often is very distinct in shape and color from the other petals. The lip usually is the lowest part of the flower, although it is the uppermost part in the developing bud, which turns around its axis as it grows in a process termed resupination.

The ornamental genera Cattleya, Cymbidium, Vanda, and Laelia are commonly grown for hybridization. Many hybrids have been developed for use as garden or greenhouse ornamentals and for commercial flowers. Many orchid growers have experienced orchid potting media “going bad”. Because of developed imbalances in the potting media, orchids will stop growing and eventually die.

### SUMMARY OF THE INVENTION

The invention provides fertilizer compositions that permit experts and novices to practice 3-level plant feeding and methods of use of this preparation. At the primary level, this composition provides the minerals the plant needs for photosynthesis. At Level 2, the composition comprises a diet that supplies a variety of simple carbohydrates, aminoacids and vitamins for direct ingestion by the roots. Finally, at Level 3, the composition provides complex foodstuffs to feed a population of microbes that in turn provide a steady source of nutrients for the orchid, as well as, define the environment surrounding orchid roots.

This invention led to novel compositions of fertilizer preparations that provide a feast for plants while simultaneously harnessing and sustaining microbes. The compositions manage the pH of the pot environment to keep it within the safe zone. Orchids respond phenomenally when fed a 3-Level diet no matter the composition of the potting mix. The rejuvenating benefits of 3-Level nutrition puts an end to orchid media going bad.

### DETAILED DESCRIPTION

In the present invention, this novel fertilizer composition and three-level plant feeding provides numerous and significant benefits for many plants. The phenomenon applied to orchids illustrates the invention.

The invention is drawn to:

A. Feeding of plants at the primary level by supplying them with basic elemental nutrients. Nitrogen, Phosphorous, and Potassium are considered the “big three”. These are followed by Calcium, Magnesium, Sodium, Sulfur and Chloride as minor elements, and by Iron, Zinc, Boron, Copper, Selenium, Manganese, and others as trace elements.

B. Feeding of plants at the secondary level by supplying the roots with a variety of energy-rich, carbonaceous materials that can be directly absorbed by plant roots. These include sugars like sucrose, alcohols like methanol and glycerol, simple amino acids and nucleic acids, and complex vitamins. Secondary plant feeding, typically confined to sterile conditions, is practiced in plant tissue culture and propagation.

C. Feeding of plants at the third level by providing a variety of complex foodstuffs to the microbial ecosystem that in turn nourishes the growing plant. A balanced, dynamic population of microbes supplies carbon dioxide for root uptake by plants. In addition microbes capture soluble nutrients that transiently pass through the plant ecosystem and transform them into microscopic cells of balanced, “slow release” fertilizer.

The invention discloses that, 3-level plant feeding strongly influences the pH and salt levels in the plant environment. . Dramatic changes in pH and salt levels in turn cause corresponding changes in microbe and plant metabolism. An understanding of the interplay between the pH and salt level in the environment and the metabolism of plant and microbes has guided the formulation of fertilizer preparations that promote 3-level plant feeding.

All mineral nutrients commonly supplied to plants are salts; and consequently, leave behind acidic, or basic, counter-ions when assimilated by plants or microbes. Depending upon which counter-ions remain in excess the environment will go acidic or basic.

The pH of an ecosystem is not static. It continuously changes as the chemical reactions that support plant and microbe life occur. In addition the nutrient content of water entering and leaving an ecosystem provides additional factors that alter environment pH.

An ecosystem containing decomposing matter and growing plants has additional acid and base generation reactions. Especially important are reactions that generate volatile acids and bases. Some important reactions include the following.

Carbon Dioxide Release and Uptake

Living cells oxidize carbonaceous molecules to Carbon Dioxide. These reactions occur in water confined within the cell. Carbon Dioxide reacts with water to form Carbonic Acid, H₂CO₃. If the water is alkaline, as occurs when it contains Sodium Hydroxide, Carbonic Acid will be neutralized by the NaOH to produce the monobasic salt, Sodium Bicarbonate, NaH(CO₃). If the water is sufficiently alkaline, Sodium Bicarbonate will react with a second NaOH to produce the dibasic salt, Sodium Carbonate, Na₂(CO₃).

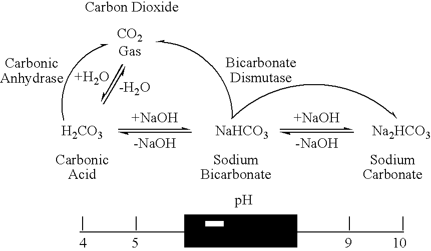

Cellular oxidations occur within cells surrounded by membranes. Organisms that derive their energy from oxidations have active molecular pumps that carry large amounts of Carbon Dioxide out of their cells. Conversely, plants that rely upon photosynthesis actively pump Carbon Dioxide into their leaf and root cells.

Carbon Dioxide is an elusive acid because it readily vaporizes from water. Consequently, to get a firm handle on Carbon Dioxide, living cells usually transfer it across cell membranes as the Bicarbonate ion, which is the predominant carbonate form at neutral cellular pH. To maintain electro-neutrality, the cell must compensate by either simultaneously pumping a companion mono-valent (Sodium or Potassium) ion, or it must effectively pump a hydroxide ion back across the membrane in the opposite direction. Needless to say, in the course of evolution, both plant and microbe cells have acquired a variety of enzymes that promote Carbon Dioxide traffic into, and out of, cells in a manner that supports basic cell needs.

When environmental microbes digest their food, they release large amounts of Carbon Dioxide, which reacts with soil moisture to form Carbonic Acid. Plants claim some of the Carbonic Acid. The remainder dissociates into Carbon Dioxide and water. Under ordinary conditions, the dissociation of Carbonic Acid is fairly slow; consequently, the water around a growing cell becomes acid.

Some microbes, called the “acid gang” have acquired the ability to live in highly acidic conditions. Other microbes, called the “basic gang” take steps to rid the environment of Carbonic Acid. They excrete into the environment large amounts of an enzyme, Carbonic Anhydrase, which highly accelerates the dissociation of Carbonic Acid. This enzyme is so effective in removing Carbonic Acid from the environment that it drives the pH around the cell highly alkaline, in excess of 8.

Evidence suggests that excreted Carbonic Anhydrase behaves more like a Bicarbonate Dismutase, i.e., an enzyme that rearranges two bicarbonate ions into a molecule of gaseous Carbon Dioxide and a Carbonate ion. This is more than a mechanistic distinction. If the environment contains Bicarbonate ions to accelerate root uptake of Carbon Dioxide, the Dismutase quickly drives the pH strongly alkaline (pH >8.5), even in the presence of rapid cellular metabolism and concomitant Carbon Dioxide emission.

Because plant roots rapidly take up Carbon Dioxide from the root environment in the form of Bicarbonate Ions, one wants to maintain as high a concentration of Bicarbonate Ions as possible to enhance the rate of uptake. Unfortunately, this objective is severely restricted by the Dismutase enzyme, which destroys the bicarbonate ions and raises environment pH.

Bicarbonate Dismutase activity appears to be inhibited at pH lower than 7. Keeping a meaningful concentration of Bicarbonate sufficient to promote root uptake means that it becomes necessary to maintain environmental pH less than 7.

The presence or absence of Anhydrase/Dismutase activity seems to be the factor that separates the acid gang from the base gang. It presently is not known if the acid gang microbes lack the enzyme(s), or whether they produce inhibitors to the enzyme(s).

The incredible bottom line, Carbon metabolism will drive the environment 10 either acidic or basic depending upon the local concentration of bicarbonates and the presence or absence of Anhydrase/Dismutase enzyme.

Nitrogen Metabolism

The metabolism of Nitrogen in an ecosystem is no less complicated than that of Carbon Dioxide. Nitrogen can be supplied to the plant ecosystem as ammonium salts, or as Nitrate salts.

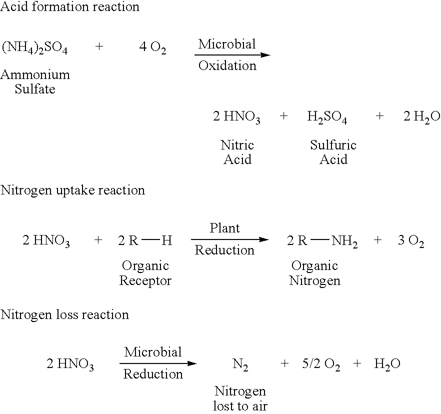

When an ammonium ion is taken into a cell, a hydrogen ion, H⁺ is ultimately left behind. An ecosystem fed Ammonium Sulfate, (NH₄)₂SO₄, releases a molecule of Sulfuric Acid, H₂SO₄, for each molecule of Ammonium Sulfate utilized. The opposite effect occurs when a Nitrate ion is taken into a cell. Each Sodium Nitrate, NaNO₃, taken into a cell ultimately releases a molecule of Sodium Hydroxide, NaOH. This explanation suggests the importance of Ammonium Nitrate in plant food because after complete metabolism, it leaves no pH-affecting residue behind.

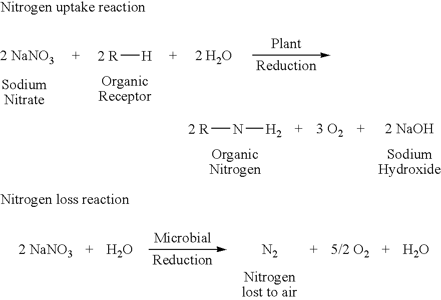

In general ammonium salts are toxic to cells. Consequently microbes have long ago acquired the ability to oxidize ammonium ions ultimately to nitrate ions. Before nitrate ions can be incorporated into cellular building blocks, they must again be reduced to organic amines. In addition, nitrates serve as a source of oxygen for some microbes struggling under near anaerobic conditions. Often the end product of these Nitrogen reducing reactions is inert Nitrogen gas, N₂. The net effect, nitrogen supplied to a plant ecosystem is often quickly lost as inert gas even as the ecosystem is left polluted with strong acids or bases.

Under acidic environmental conditions, the end product of Nitrogen salts is predominantly Nitric Acid, HNO₃. Under alkaline conditions, the metabolic end product is Nitrogen gas. Either way, Nitrogen not immediately used by plants or microbes is rapidly dissipated from the ecosystem.

Urea Hydrolysis

As a source of Nitrogen, urea, H₂N-CO-NH₂, presents both danger and opportunity. On the plus side, under appropriate metabolic conditions, urea is a Nitrogen source that leaves no harmful residue behind. On the negative side, incomplete or slow metabolism of urea can cause the build-up of toxic ammonia that can raise environmental pH to dangerous levels.

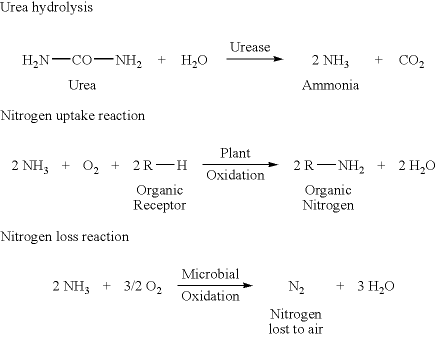

Some microorganisms excrete an enzyme, Urease. This highly effective enzyme rapidly hydrolyzes urea to one molecule of Carbon Dioxide, and two molecules of ammonia. Because Carbon Dioxide is subject to evaporation, this reaction rapidly increases environmental pH by the production of Ammonium Hydroxide. Once in the environment, Urease will hydrolyze urea to Ammonia even though the excreting microbe is no longer alive.

If microbes have an abundance of energy-rich carbon foods, and plenty oxygen, they will rapidly oxidize toxic ammonia to harmless nitrates. These nitrates become available for plant or microbe metabolism or if in excess, decomposition to molecular Nitrogen.

On the other hand, if energy food to support microbe growth is lacking, or if conditions go anaerobic, the microbes are unable to detoxify ammonia by transformation to nitrate. When this sequence occurs, ammonia buildup can quickly kill plants.

In summary, the addition of energy-rich microbe foods in the plant fertilizer permits the safe use of urea as the major nitrogen source. The environment benefits because urea leaves behind no harmful pH shifting salts.

Phosphate as Muscle for Controlling pH.

The buffering capacity of Phosphate salts provides the primary pH control that compensates for the acids and bases generated by Carbon and Nitrogen metabolism. Even though phosphorous is a minor component of living cells, the ability to keep soil pH within acceptable limits accounts for why phosphorous has long been recognized as a primary plant nutrient.

In the pH range from 4 to 10, the Phosphate anion exists as an equilibrium of the free acid H₃PO₄, the monobasic salt, H₂PO₄⁻¹, the dibasic salt, HPO₄⁻², and the tribasic salt, PO₄⁻³. The acid and monobasic salts of Phosphate tend to be soluble, and consequently will readily leach from the soil. On the other hand, the dibasic and tribasic salts will combine with Calcium and Magnesium to make insoluble salts.

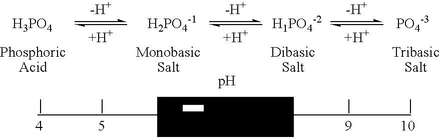

Taken together, the above Phosphate chemistry, make it the principle regulator of soil pH. In a chemical sense, Phosphate concentration becomes the valve that determines the amount of Nitrogen and Carbon metabolism that is permitted to flow. This property makes Phosphate the major pollutant of run-off water. Consequently, intelligent fertilizer design should seek to optimize, and thereby minimize, the use of Phosphate.

Planning 3-Level Fertilizer for Pot Plants

A fertilizer that feeds plants while simultaneously feeding microbes for the insitu synthesis of balanced, slow-release nutrients offers significant advantages beyond current technology. The following disclosure teaches how to construct a powdered fertilizer formulation used at 1 tablespoon per gallon applying the science described above.

It is important to note that the described formulation goes far beyond the simple ratios of elements provided by most fertilizer preparations. Because pH and salt content are critical parameters, it provides the exact chemical species used in a balanced formula. Using the principles disclosed, one skilled in chemistry and biochemistry can formulate any number of combinations to achieve the same end-point.

Step 1, Phosphate. Start with an amount of Phosphate that can provide adequate pH buffering. For a nominal 100 grams of fertilizer, at least around 5 g of monobasic Calcium salt of Phosphate, commonly labeled Super Triple Phosphate. A working range of 5-35 grams of monobasic Calcium salt of Phosphate, preferably 5 g of monobasic Calcium salt of Phosphate can be used. This provides the principal acid component in the formulation.

Step 2, Potassium Bicarbonate. For a nominal 100 grams of fertilizer, at least around 1.42 gram Potassium Bicarbonate is added. This amount when hydrolyzed by Bicarbonate Dismutase balances the buffering capacity of the Phosphate. A working range of 1-10 grams of Potassium Bicarbonate, preferably, 1.42 gram Potassium Bicarbonate can be used. This also maximizes the Bicarbonate concentration to enhance CO₂ uptake by plant roots.

Step 3, Nitrogen Sources. For a nominal 100 grams of fertilizer, at least around 7 grams of urea, plus equal moles of Ammonium sulfate, 0.94 g, and Sodium Nitrate, 1.21 g is added. (Use of additional Ammonium Sulfate or Sodium Nitrate are potential possibilities to regulate final pH in the soil ecosystem.) These Nitrogen sources provide immediate nitrogen for plant and microbe uptake. A working range of 7-30 grams of urea; preferably at least 7 grams of Urea can be used. Use of Urea results in a minimal net contribution to residual salt build-up.

Step 4, Potassium. For a nominal 100 grams of fertilizer, at least 2 grams of Potassium Chloride is added. This amount plus the Potassium from K₂HCO₃, Step 2, equals 1 Potassium per Phosphate. A working range of 2-10 grams; preferably 2 grams of Potassium Chloride can be used.

Step 5, Citric Acid. For a nominal 100 grams of fertilizer, at least around 0.683 g citric acid is added. This amount serves to chelate Calcium and provides a starting pH near 6.5. Citric Acid serves as a regulator for the Urease and Carbonic Anhydrase enzymes. Its level determines the rate and extent of pH shifts caused by Bicarbonate and Urea concentrations. Note, upon complete oxidation, citric acid leaves no residual acid in the environment. A working range of 0.683-8.0 grams of citric acid; preferably 0.683 g citric acid can be used.

Step 6, Microbe nutrients. For a nominal 100 grams of fertilizer, at least around 20 grams sucrose, corn flour—around 20 g, whole-wheat flour (or an alternate energy source)—around 15 g, yeast food—around 11 g, Purina Animax—around 11 g, and vegetable oil—around 5 g. These nutrients provide a wide range of carbohydrates, proteins, fats and vitamins that sustain a broad population of microbes that are unlikely to be plant pathogens. Plant roots can directly absorb many of these nutrients. Any balanced combination of agricultural plant and animal byproducts can serve as microbe nutrient. The objective is to provide a broad range of carbohydrates, proteins and vitamins, that will support a diverse population of microbes. Ideal carbohydrate sources do not support microbes that have the capability to digest plant cell walls.

Step 7, Optional pH indicator. For a nominal 100 grams of fertilizer, at least around 0.1 g Phenol Red is added. The pH indicator permits the user to visually monitor the pH of the seepage that comes out of the pot after watering. If seepage is clear/yellow, the pH is below 7. If seepage is red, the pot is dangerously alkaline, and immediate steps should be taken to lower it.

As far as possible, the above ingredients are blended in a flour-mill. Even when finely ground, the flours in the fertilizer result in a suspension when placed in water. Insoluble flours in the fertilizer solution are of no concern because the flours serve as microbe food that will eventually be solublized by microbial enzymes.

The above formulation is well balanced to maintain soil pH near 7. When added to irrigation water at 1 tablespoon per gallon, the pH of the fertilizer solution is below 6.5. When applied to soil, it drops the pH below 7. As the microbes begin digesting their nutrients, and the Anhydrase/Dismutase enzyme begins to work on the added Bicarbonate, the pH slowly increases to about 7.4. After a few days, the pH very slowly retreats toward 7. The exact pH profile depends upon local environmental parameters.

If for some reason the terminal pH needs to be adjusted, this may be done changing the amount of bicarbonate in the fertilizer preparation. Additional Bicarbonate will make the final pH higher, and less Bicarbonate will make it lower.

Effective 3-Level Feeding

The manner that plants are provided with 3-level nutrition is nearly as important as the composition of the fertilizer. Although 3-lever fertilizer is more forgiving than conventional mineral fertilizers, it still remains important to apply the fertilizer consistent with the natural cycles of the plant.

The formulation described above was designed for use at 1 tablespoon per gallon. Typically, each plant is given enough water-fertilizer to soak the pot without excessive run-off. Surfactants in the fertilizer enable the fertilizer solution to rapidly wet the soil, even when applied to dry pots. Although minimal run-off will eventually cause the build-up of excess salts by evaporation, experience to date indicates that most plants do well if flushed once a month with pure water.

Because 3-Level nutrition includes feeding environmental microbes it often proves helpful to feed plants held dormant by inclement weather. Although photosynthesis may be dormant, underground roots continue to absorb nutrients for metabolism. In addition, soil microbes capture available nutrients and incorporate them into cells that later become packets of slow-releasing fertilizer. However, sometimes plants go dormant due to diseased or salt/pH-injured roots. If these plants are given nutrition, it will generally hasten root loss and plant death.

The described fertilizer composition is not recommended for foliar feeding. Although the fertilizer contains many nutrients that are directly assimilated by leaves, the insoluble flours may leave a white residue on the leaves. It addition, it is not recommended to permit nutrient solution to stand in the crown of plants where growing microbes can infect the plant. On the other hand, the microbes supported by the fertilizer nutrients generally do not infect plants. Although the inventor has sprayed many plants with nutrient solution, he has yet to document disease caused by fertilizer standing in the crown of plants. It is yet too early to rule out that water-fertilizer standing in the crown will not propagate plant disease.

Plants given 3-Level nutrition generally shift gears into rapid growth. Although it is fun to watch plants set on new leaf and root growth, if flowers are the objective, it may be necessary to take away the 3-Level nutrition. If 3-level nutrition is stopped, the pH of the soil environment will gradually drop as residual carbon foods are metabolized and as buffering Phosphate and Carbonate salts are eluted from the soil. This pH transition is often very beneficial in jolting plant into a phase of growth.

Importance of Microbes in Soil

From the dawn of life, plants and microbes have coexisted together for their mutual benefit. A number of mutual benefits are realized by the balanced feeding of plants and soil microbes.

For plants like orchids, the Bicarbonate Ion provides a rather tight chemical coupling between Carbon Dioxide given off by microbes and the Carbon Dioxide taken up by the plant roots. Both the rate and amount of growth of plants absorbing Carbon Dioxide through both roots and leaves far exceeds that achieved when CO₂ uptake is restricted to leaves.

The rapid growth of microbes enables them to rapidly capture mineral nutrients that are carried by water flowing through the soil environment. Importantly, they capture a balanced array of nutrient minerals. Later, decomposing microbes serve as a constant supply of nutrients for growing plants.

Microbes are critically important for removing toxins from the environment. They are essential for the removal of excess amine and urea nitrogen. In addition, they sequester toxic heavy metals that interfere with the bio-reaction upon which complex life depends.

A balanced population of soil microbes contributes significantly to soil homeostasis. Microbes provide most of the soil's capacity to neutralize pH changes. They also provide a majority of the soil's ion exchange capacity.

The importance of the described 3-Level feeding program is that it enables the grower to cultivate a balanced microbe population that provides the benefits listed above while avoiding the problems that can result from unchecked microbe growth.

3-Level Feeding of Orchids

Growers long ago learned that orchids did not thrive when grown on “plain soil”. Consequently numerous “soil-less mixes” that contain various types of organic material have been advocated and tested for growing orchids. Beyond fancy language, orchids respond best when growing on a compost pile.

Not all compost piles serve the needs of orchids. Suitable piles basically provide a steady decomposition that occurs slowly over long times, seasons. Controlled microbial decay is the crucial ingredient in sustaining happy orchids. Orchids languish, sometimes unto death, when microbial decay is nonexistent as happens when orchids are planted in new mix. Excessive, uncontrolled microbial decay that drives the environment pH to extremes, or that causes the media to become anaerobic, are equally problematic. These conditions cause potting mix to go bad.

Unaware of this connection, growers empirically formulated mixtures of rot resistant bio-materials that provide slow microbial decay for potting material. These potting mixes combined with regular repotting are the foundation of today's successful orchid culture.

Orchids growing on decay resistant potting material respond favorably to 3-Level feeding. On the front end, 3-Level feeding rapidly establishes nutrient- providing, microbial cultures that sustain orchid transplants trying to gain a foothold in new media. On the back end 3-Level feeding prevents the rapid media decay and damaging pH shifts that cause potting mix to go bad. It does this by supporting a broad spectrum of microbe types that competitively restrain the microorganisms responsible for media decay.

Carbon Dioxide is a primary nutrient that microbes supply to orchids. 3- Level feeding supplies a wide range of nutrients that support a balanced, microbe population that emits a constant supply of CO₂ for uptake by orchid roots. It also supplies the maximal amount of Bicarbonate ions that serve as the chemical link between CO₂ given off by microbes and the CO₂ taken in by roots.

The microbe population supported by 3-Level feeding is critical for managing the toxicity of ammonia Nitrogen. Through a complex series of chemical transformations, microbes convert residue-free Urea into a variety of organic nitrogen that is ideal for plant uptake. Equally important, growing microbes detoxify an unknown range of heavy metals, organic bio-toxins and plant pathogens that adversely impact orchids.

Microbes ultimately serve orchids by rapidly capturing soluble nutrients that would otherwise be carried away by water flow. In the end the microbe becomes a microscopic packet of balanced, slow-release fertilizer.

Orchids provided 3-Level nutrition respond in many dimensions, not all of which are yet recognized. The responses observed in the inventor's orchid collection during the optimization of the 3-Level fertilizer are categorized below. Given the vast diversity in orchids there naturally is a broad spectrum of responses to 3-Level feeding.

Faster growth, earlier maturation. Orchids introduced to 3-Level nutrition show a rapid spurt of growth. Often Phalaenopsis leave a record of this growth spurt as notches in the leaves.

Stronger more luxurious growth. Leaves produced after 3-Level feeding typically are much greener, thicker, and more crisp. Cattleya, Cymbidiums, Dendrobiums, Phragmipediums, Miltonias, Oncidiums, Paphiopedilums, Phalaenopsis, and Zygopetalums show this response.

Increased size. Orchids provided 3-Level nutrition often become huge. Phalaenopsis leaves regularly become twice as long and twice as broad when switched to 3-Level feeding. The leaves of Cymbidiums, Zygopetalums, and Paphiopedilums all become much larger when given 3-level feeding.

Improved root growth. In addition to maintaining the pH of the environment, 3-Level nutrition provides a pantry of nutrients that can be directly assimilated by orchid roots. The rapid, luxurious leaf growth reflects equally robust root growth. The 3-Level fertilizer strongly stimulates the proliferation of root buds that ultimately leads to dense root growth.

Increased photosynthetic capacity. Orchids kept moist with 3-level nutrition, and given an opportunity to acclimate to sunlight can withstand very intense light. 3-Level fed orchids stay healthy green under light conditions that bleach orchids given conventional treatment. If given plenty of air circulation to prevent heat build-up, most orchids can thrive in direct sunlight. This ability results from providing the orchid sufficient CO2 to effectively utilize photo-activated metabolites before they can do irreparable damage to chloroplasts.

Faster recovery after transplantation. To some degree, repotted orchids suffer chronic nutrient deprivation, and persistent poisoning from poly-phenolic compounds leached from bark chips, after repotting. 3-Level nutrition feeds a diverse population or microbes that mitigates these setbacks within a few days, instead of weeks or months that are required when microbes must gain a foothold on decay-resistant media.

Reduced need for repotting Orchid media goes bad when the microbes digesting the media drive the environmental pH either above or below safe limits. When this occurs, inability to take in nutrients cause roots to starve and subsequently to decay. The described 3-level fertilizer acts at two levels to preserve the quality of the growth media. First it provides sufficient Phosphate buffer to maintain pH within acceptable levels. Second, it supplies a broad spectrum of nutrients that feed a diverse population of microbes that competitive inhibit the microbes that break down the media. Present evidence indicates 3-Level feeding will completely alleviate the need to repot orchids due to media breakdown.

Shocking dormant plants into growth. The nutrients in 3-Level fertilizer have a powerful ability to shock dormant plants into active growth. This is particularly true if dormancy resulted from injured roots. This capability of 3-Level nutrition needs to be applied with understanding. Orchids shocked to set buds under conditions unsatisfactory for sustaining growth may lead to the rapid death of the plant.

Increased leaf bud formation. Orchids treated as described with 3-Level nutrition frequently set a higher number of leaf/stem buds. Cattleyas often set 2-3 pseudobulbs instead of one. Phragmipediums, Oncidiums, Paphiopedilums, and Zygopetalums often set multiple new growths instead on one. Four and five new growths are not uncommon.

Improved resistance to temperature extremes. When orchid roots are given nutrients directly, the plant is much better equipped to survive winter low temperatures and short cloudy days. The inventor's collection survived extended periods of day-time highs in 50s and 60s and night-time lows in 40s and 50s with little apparent damage. The same is true for high summer-time temperatures when plants are outdoors in direct afternoon sun.

Increased rate of flower and leaf senescence. When 3-level nutrition is introduced to orchids presently in bloom, it is not uncommon for the plant to drop developing buds and flowers as the plant shifts into high growth. Likewise, aged leaves that have remained green for months and years will often turn yellow and die within a few days. These reactions emphasize that orchids must be treated with 3-Level nutrition in a manner that is consistent with the natural cycles of the plant.

Failure to set flowers spikes or for spikes to set flowers. Some orchids, growing rapidly under optimal growth conditions will fail to set spikes or fail to set flowers on spikes. Cymbidiums are particularly subject to this phenomenon, and if provided continuous nutrient, will grow year-around without setting flowers. This can be a great way to grow giant specimens, but will not flower annually.

Preferred Embodiment

The following formulation teaches one embodiment of this invention. Those skilled in biochemistry and nutrition can modify the formulation disclosed in numerous ways to achieve equivalent performance.

Ingredients per 100 g:

Group 1.

| | |
|---|---|
| 1. Corn Meal | 13 g. |
| 2. Whole Wheat Flour | 12.5 g. |
| (or an alternate energy source) | |
| 3. Yeast Food | 12.5 g. |
| 4. Animax | 12.5 g. |
| 5. Calcium Phosphate, Monobasic salt | 10 g. |
| 6. Potassium Chloride | 4 g. |
| 7. Ammonium Sulfate | 3 g. |

Group 2.

| | |
|---|---|
| 1. Sucrose | 12.5 g. |
| 2. Urea | 14 g. |
| 3. Potassium Bicarbonate | 2.5 g. |
| 4. Sodium Nitrate | 1.25 g. |
| 5. Citric Acid | 1 g. |

Group 3.

| | |
|---|---|
| 1. Vegetable oil | 6 g. |
| 2. Phenol Red, Sodium Salt | 0.05 g. |

Yeast food available from Diamond Mills Inc., Cedar Rapids, Iowa, 52407, contains Saccharomyces Cerevisiae yeast and the media on which it is grown consisting of ground yellow corn, hominy feed, corn gluten feed, wheat middlings, rye middlings, diastatic malt, and corn syrup and cane molasses. It is an animal feed supplement obtained as a byproduct of alcohol production. Yeast food is added as a source of bio-nutrients, as well as, trace minerals.

Animax is a pelleted feed product by Purina Mills recommended for cattle, swine, and poultry. It is a balanced formula that is antibiotic free and contains plant and animal proteins along with vitamins and trace minerals.

The monobasic salt of Calcium Phosphate is sold as triple super phosphate.

Potassium Chloride is usually sold as potash and sometimes identified as muratic salt.

Procedure:

Combine the Group 1 ingredients together and grind in a flour-mill. Combine Group 2 ingredients together and homogenize in a mechanical mixer.

Combine products from Group 1, 2 and 3 and mix thoroughly in a mechanical mixer. The final fertilizer product is a dust-free powder.

For use, combine fertilizer product with irrigation water at a rate of 1-tablespoon fertilizer per gal water. Apply to pot plants until wet. Avoid excessive run-off.

What is claimed is:

1. A fertilizer composition that feeds plants while simultaneously feeding microbes for the insitu synthesis of balanced, slow-release nutrients comprising a 3-level nutrition, consisting essentially of minerals, simple carbohydrates, aminoacids, vitamins and an optional pH indicator.

2. The composition of claim 1, further comprising three groups wherein the first group comprising Corn Meal, Whole Wheat Flour, or an alternate energy source, Yeast food, Animax, Calcium Phosphate, Potassium Chloride and Ammonium Sulfate; a second group comprising sucrose, urea, potassium bicarbonate, sodium nitrate and citric acid; and a third group comprising vegetable oil and Phenol Red.

3. The composition of claim 1, comprising Phosphate that can provide adequate pH buffering, Potassium Bicarbonate, Nitrogen Sources, Potassium, Citric Acid, Microbe nutrients, and an optional pH indicator; wherein said compositions result in a pH of about 7 and the salt concentration are minimal.

4. The composition of claim 2, comprising 10 g of monobasic Calcium salt of Phosphate, 2.5 gram Potassium Bicarbonate, Nitrogen Sources of at least around 7-14 grams of urea, plus Ammonium sulfate, 3 g, and Sodium Nitrate, 1.25 g, Potassium of at least around 4 grams of Potassium Chloride or a formulation of wherein 1 Potassium per Phosphate, Citric Acid of at least around 1.0 g citric acid, Microbe nutrients, of at around 12.5 grams sucrose, corn flour-around 13 g, whole-wheat flour, or an alternate energy source, - around 12.5 g, yeast food - around 12.5 g, Purina Animax- around 12.5 g, and vegetable oil-around 6 g, and an optional pH indicator of at least around 0.05 g Phenol Red.

5. The composition of claim 2, further comprising
Group 1
130 grams of Corn Meal,
125 grams of Whole Wheat Flour, or an alternate energy source
125 grams of Yeast Food
125 grams of Animax
100 grams of Calcium Phosphate, Monobasic salt
40 grams of Potassium Chloride
3 grams of Ammonium Sulfate
Group 2
125 grams of Sucrose
140 grams of Urea
25 grams of Potassium Bicarbonate
12.5 grams of Sodium Nitrate
10 grams of Citric Acid
Group 3.
60 grams of Vegetable oil
0.5 grams of Phenol Red, Sodium Salt

6. A kit comprising a fertilizer composition of any one of claims 1-5 and instructions which directs a user to effectively perform methods of use for plants.

7. A method of stimulating growth and recovery of injured plants comprising applying an effective amount of a fertilizer composition of any one of claims 1-5.

8. The method of claim 7, wherein the soil or media is flushed once around month with pure water.

9. The method of claim 7, further comprising a combination of the fertilizer composition with irrigation water at a rate of 1-teaspoon-1 tablespoon fertilizer per gal water.

10. The method of claim 7, wherein conditions for anaerobic microbial growth are minimized.
